(19) United States
(12) Patent Application Publication
(10) Pub. No.: US 2023/0162113 A1
(43) Pub. Date: May 25, 2023

(54) KNOWLEDGE BASE RECOMMENDATIONS

(71) Applicant: Hewlett-Packard Development Company, L.P., Spring, TX (US)

(72) Inventors: Rafael Dal Zotto, Porto Alegre (BR); Juliane da Rocha Alves, Porto Alegre (BR)

(73) Assignee: Hewlett-Packard Development Company, L.P., Spring, TX (US)

(21) Appl. No.: 17/921,113

(22) PCT Filed: Apr. 28, 2020
(86) PCT No.: PCT/US2020/030283

§ 371 Date: Oct. 25, 2022

(51) Int. Cl. G06Q 10/0631; G06Q 10/0639; G06N 5/04

(52) U.S. Cl. CPC G06Q 10/06315; G06Q 10/06398; G06N 5/04

(57) ABSTRACT

In an example implementation according to aspects of the present disclosure, a system, method, and storage medium for knowledge base recommendations are disclosed. A system comprising a storage medium and a processor receive user usage data from a telemetry agent. The processor creates a knowledge base based on the user usage data. The processor segments the knowledge base based on a profile and determines an optimal computing device recommendation and an optimal software application recommendation. The processor transmits the recommendations to a provisioning system.

### BACKGROUND

A specific job can utilize specific hardware and software to perform the designated job task assigned. Computer systems may collect telemetry on their relating to hardware configurations and software applications utilized to accomplish the job task.

### BRIEF DESCRIPTION OF THE DRAWINGS

FIG. 1 illustrates a knowledge base recommendation system, according to an example;

FIG. 2 is a block diagram corresponding to creating knowledge base recommendations, according to an example;

FIG. 3A and FIG. 3B are illustrations of relationships used in creating knowledge base recommendations according to an example; and

FIG. 4 is a computing device for supporting instructions for creating knowledge base recommendations, according to an example.

### DETAILED DESCRIPTION

In an office environment, users utilize computing devices to perform job tasks. Certain computing devices may be inherently better equipped to fulfill job functions than others. For example, a content creator may utilize a device with a more precise video display device than an administrator. Additionally, a software developer may utilize more processing cycles and memory than a user in a management role. Likewise, the software applications each job family may vary as well. Software developers may utilize compilers and integrated development environments (IDEs). Content creators may utilize graphical and video editing software. Managers may utilize productivity software. When a new employee joins an organization in a particular job role, the new employee may be handed a computing device. The computing device often may be a “one-size fits all,” where the computing device does not match the specific job role and does not have the appropriate tools for the job installed. The new employee then has to identify the required software and install themselves or with the help of colleagues or tech support. It is disclosed herein, a system to determine optimal device and software configurations and provision a computing device in accordance.

In one example, a processor receives user usage data from a telemetry agent. The processor creates a knowledge base based in part on the usage data. The processor segments the knowledge base based on a profile. The processor determines an optimal computing device recommendation and an optimal software recommendation based on the profile. The processor transmits the optimal recommendations to a provisioning system.

In another example, a processor receives a user software application usage data from a telemetry agent. The processor receives a first job profile and a second job profile. The processor extracts a first software application profile from a knowledge base. The first software application profile corresponds to the first job profile. The processor extracts a second software application profile from the knowledge base. The second application profile corresponds to the second job profile. The processor compares the user software application usage data to the first software application profile and the second application profile. The processor transmits a job profile recommendation to the third-party system based on the comparison.

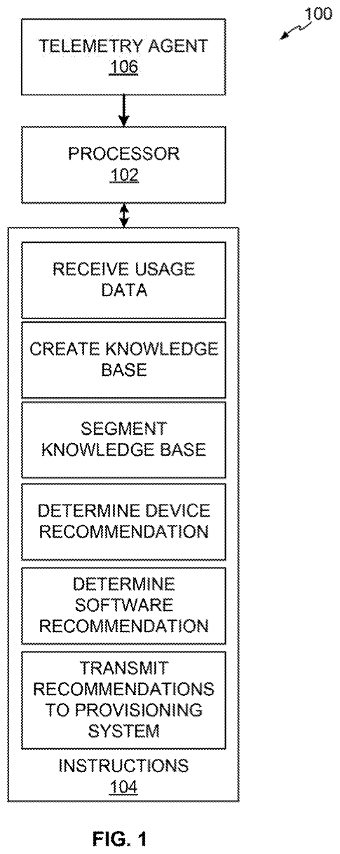

FIG. 1 illustrates a knowledge base recommendation system 100, according to an example. The system may include a processor 102, instructions 104 and a telemetry agent 106.

The processor 102 may be implemented as a general-purpose processor such as a central processing unit (CPU). The processor 102 may also be implemented as a virtual processor. A virtual processor may be abstracted from a specific piece of hardware and may be defined by the workload it processes. A virtual processor may be a cloud processing instance, or a virtual machine instance. The processor 102 may be connected to supporting electronics including a host system and a network (not shown) to facilitate the operation of the processor.

The processor 102 may be able to process instructions 104. The instructions 104 may be firmware or software to change or control the behavior of the processor 102. For example, instructions 104 for the processor 102 may including receiving usage data, creating a knowledge base, segmenting the knowledge base, determining a computing device recommendation, determining a software application recommendation, and transmitting those recommendations to a provisioning system. The instructions 104 may be stored in a non-transitory storage medium.

A telemetry agent 106 may reside on a plurality of additional computing devices. The telemetry agent 106 may be utilized by an organization as a way of pushing updates (e.g. security fixes, software features) to targeted computing devices within the organization. Additionally, a telemetry agent 106 may collect information about the computing device and its usage. The telemetry agent 106 may collect information relating to the hardware of the computing device. The hardware may include but is not limited to information about processor model, installed memory, graphics adapter, display resolution and type, peripherals, and network connection. The information relating to the hardware may capture aspects of the hardware in operation that may be relevant to a certain use case for the user of the computing device. The information relating to the hardware may capture operating aspects of the hardware in operation to determine device health with software application usage pattern.

The telemetry agent 106 may also collect information relating to the software of the computing device. The software may include but is not limited to information about the operating system, applications installed, and applications used (including frequency and duration). Like the hardware information, the information relating to the software may capture aspects of the software in operation that may be relevant to a certain use case for the user of the computing device.

The telemetry agent 106 may be connected to the processor 102 by underlying networking structure (not shown). The underlying networking structure may include wired or wireless networking infrastructure including a networking adapter, as well as available LAN, WAN and Internet connectivity. In another implementation, the telemetry agent 106 and the processor 102 to execute the instructions may co-exist on the same physical computing device.

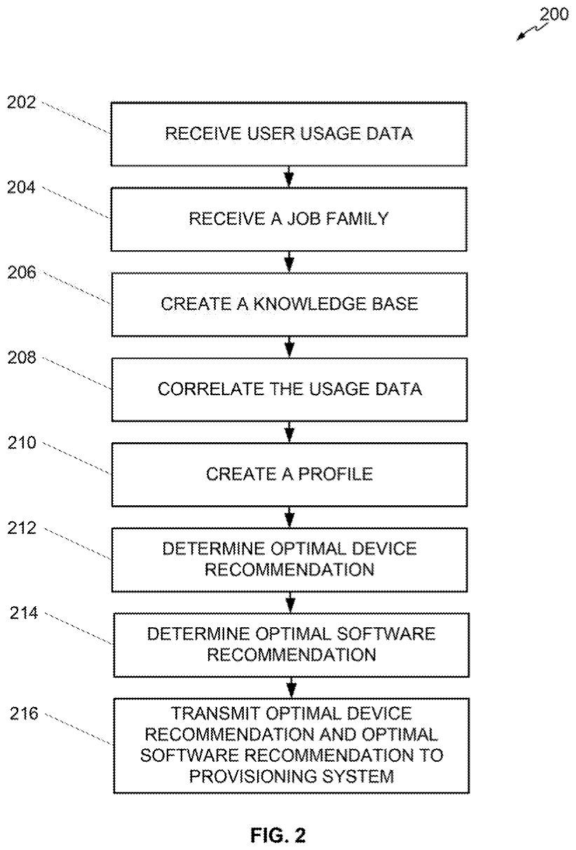

FIG. 2 is a block diagram 200 corresponding to creating knowledge base recommendations, according to an example. In an effort to better describe the block diagram 200, features of FIG. 1 may be utilized and referenced.

At 202, the processor 102 receives user usage data from a telemetry agent. The usage data corresponds to a software usage pattern and a hardware utilization pattern of a user. A telemetry agent may log launched applications and monitor active usage within each application launched. The logged information may be aggregated and packaged at the telemetry agent as user usage data and transmitted periodically to the processor 102. In another implementation, the telemetry agent may immediately package the logged information as user usage data and stream the user usage data to the processor 106. The packaging of the logged information into the user usage data may include incorporating identifiable markers which allow the processor 102 to correlate the logged information to the user. Additionally, the packaging may include computing device information that identifies component of the computing device being monitored by the telemetry agent 106. For example, the computing device information may include the information including model of the computing device, the type of processor, the installed memory, battery capacity, the type of graphics adapter, and display type and resolution.

At 204, the processor 102 receives a job family from a third-party system. A user within an organization often has a job title or job identifier associated with their position. Additionally, that job identifier belongs to a job family which encompasses a similar group of related positions. For example, a job identifier “Expert Software Engineer” which describes a roll within an organization may have a job family entitled “Software Engineer” which describes a group of job identifiers with similar roles. In another implementation, another descriptor may define a job identifier and set them apart from others of the same job identifier. For example, a team may have three “Expert Software Engineers,” however there also a “Technical Leader” which further describes the relationship between them. A third-party system may be a system logically separate from that which the processor 102 operates. For example, the third-party system may be a human resources system that contains information corresponding to employees and contract workers for the organization. The information within the third-party system may include performance reviews, salary information, office location, job identifier, job family, and management chain. The third-party system may be virtually hosted on the same physical system as the processor 102, however logically the third-party system remains separate and transmits the job-family through an interface known to the processor 102.

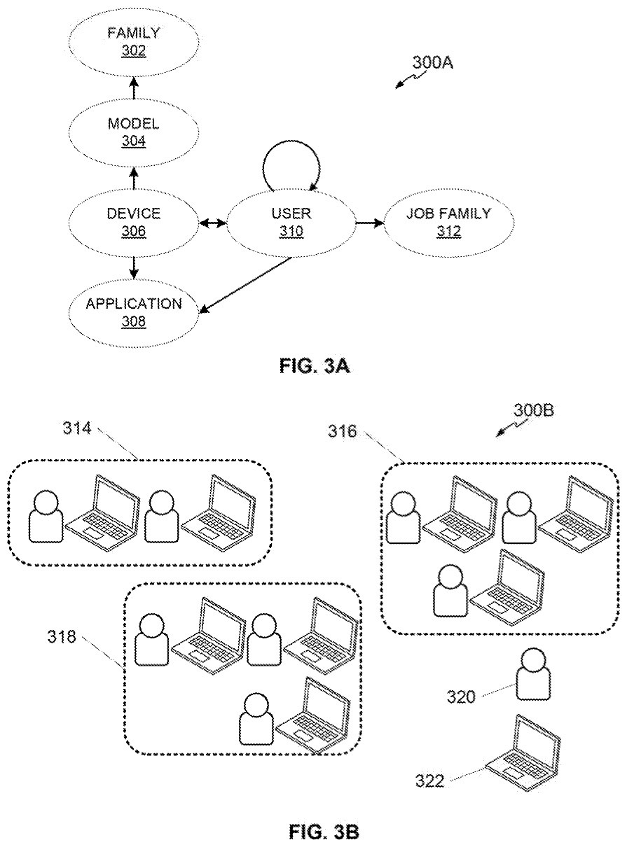

At 206, the processor 102 creates a knowledge base based in part of the usage data and the job family. The knowledge base may define correspond to a defined ontology utilized to store complex structed and unstructured information. In one implementation, a knowledge base may be implemented as a knowledge graph. The knowledge base defines a relationship between the user, the job-family, an associated computing device (and its model family) and a host of applications the user uses on the device. An example of a knowledge base created using this ontology is described in further detail in relation to FIG. 3A. However, in one implementation, the knowledge base may group the job family from the knowledge base exclusive of a user node, which allows generalization of the job family to be described in terms of traversing the graph for the corresponding software applications and computing devices utilized. In another implementation, the job family may be partitioned into sub-nodes of the knowledge base, to further differentiate a hierarchy of jobs within an organization, thereby identifying specific software applications and computing device recommendations on a more granular job family basis.

At 208, the processor 102 correlates the user usage data, the job family, and a user based on the knowledge base. As the knowledge base defines the relationship between the usage data, the job family and the user, a data structure may be populated. As described previously, the user usage data may include identification markers identifying the user and the device for which any logged information was obtained. In one implementation, the identification markers may include a user id that may correspond to an entry in the third-party system. The user id may be used as a key to query the third-party system for a corresponding job family for the user id. The query may correspond to a standardized structured query language request, utilizing a RESTful application programming interface (API), or a proprietary API into the third-party system. The correlation may include linking the user usage data, the job family and user based on a user id extracted from the user usage data.

At 210, the processor 102 creates a profile based on the correlation. The profile corresponds to a job family. The profile may be abstracted from an individual user and be expressed in terms of a job family. While traversing a knowledge graph implementation of the knowledge base, the traversal includes accessing a list of devices corresponding to users within the specified job family. Likewise, the traversal includes accessing a list of software applications corresponding to users within the specified job family. Utilizing this implementation, excluding the user from the knowledge base correlates the software applications utilized and the devices directly to the job family. The process of excluding the user from the knowledge base and organizing around the job family may be called segmentation. The segmentation effectively divides the knowledge base into portions by job family along with the correlated computing devices and software applications extracted from the user usage data. This allows the knowledge base to identify software application and devices utilized by the job family.

At 212, the processor 102 determines an optimal computing device recommendation based on the profile. The processor 102 may traverse a profile or segmented knowledge base based on job family. The profile may indicate a number of computing devices corresponding to users (now excluded in the profile) within that job-family. The processor 102 may identify a device most likely to appear in the profile. Statistically speaking, the computing device selected may be the equivalent to the mode in the set of computing devices associated with the profile. Another implementation may include a rules-based approach to determine the mode of a number of features consistent with the majority of computing devices in the profile (e.g. processor specification, installed memory, etc). The selected computing device from the profile may be used as an optimal computing device recommendation.

At 214, the processor 102 determines an optimal software application recommendation based on the profile. The optimal software application recommendation corresponds to a set of software applications commonly used by a majority of computing devices within the job family profile. Like the determination of the optimal computing device recommendation, a set of common software applications from the profile may be identified. In one example, software applications within the profile may be identified by frequency occurred within the profile. A threshold frequency may be utilized to determine whether a software application in the profile may be selected as an optimal recommendation. The threshold frequency may correspond to a percentage of installed computing devices. For example, a specific integrated development environment may occur as an installed software application in sixty five percent of the computing devices within the profile. If the threshold frequency is sixty, then the specific integrated development environment may be included with the optimum software application recommendation. In another implementation, a second threshold may be utilized as an optional software application recommendation. The second threshold may be lower than the first and provide a list of common but not majority installed software applications. The second threshold may provide a new employee user a list of optional installable applications

At 216, the processor 102 transmits the optimal computing device recommendation and the optimal software application recommendation to a provisioning system. In one implementation, the optimal computing device recommendation may include secondary computing device recommendations to allow the provisioning system to allocate a computing device based on availability. For example, the first option in the optimal computing device recommendation is temporarily unavailable in the provisioning system, so the optimal computing device recommendation may include a secondary computing device recommendation. The processor 102 may interface with a provisioning system. The provisioning system may correspond to second third party system, different from the third-party system previously utilized to obtain job family information. The provisioning system supports the ordering and delivery of computing devices. The provisioning system receives orders of computing devices as well as the specified configurations to be installed. The processor 102 may package and transmit the optimal computing device recommendation and the optimal software application recommendation in accordance to the requirements of the provisioning system. For example, a provisioning system may utilize a nested extensible markup language (XML) format to represent a computing device, where XML tags correspond to configurable components. In another implementation, the provisioning system may utilize JavaScript object notation (JSON) to describe a computing device's configuration.

FIG. 3A and FIG. 3B are illustrations of relationships used in creating knowledge base recommendations according to an example. Referring to FIG. 3A, a knowledge base 300A may include objects corresponding to a computing device family 302, a computing device model 304, a computing device 306, an application 308, a user 310, and a job family 312. The computing device family 302, the computing device model 304 may be abstract objects within the knowledge base in the fact that they exist only to describe the computing device 306 itself. For example, each computing device 306 may have an “is a” relationship (inheritance) with the computing device model 304 object and the computing device family object 302. This relationship provides information related to the computing device 306 so that a better optimal computing device recommendation may be made. For example, an individual computing device 306 may be identified as the mode within a profile (as described above), however that specific computing device 306 is no longer manufactured. Utilizing the computing device model 304 and the computing device family 302, an optimal computing device recommendation may be augmented to identify a computing device 306 that may be very similar to the identified optimal computing device.

Both the user 310 and the computing device 306 have a “has a” (composition) relationship with the application 308. The relationship between the computing device 306 and the application 308 expresses that an application is installed on the computing device 306. The relationship between the user 310 and the application 308 describes a usage of the application 308. A computing device 306 may include an installed application 308 however the user 310 may not use the application 308. Additionally, the relationship between the user 310 and the application 308 describes how much the user utilizes a given application. These two relationships allow the knowledge base and more particularly the profile to better describe and determine an optimal software application recommendation.

Within the knowledge base, a user 310 may reference another user. This reference is a “has a” relationship (composition) as well. The user 310 object of the knowledge base may also describe a managerial structure within the organization. A user 310 may have a subordinate or a manager. Likewise, the user 310 “has a” (composition) job family 312 that identifies a type of position and thereby the type of work the user 310 does.

Referring to FIG. 3B, an organization diagram 300B, illustrates the examples of the job family 312. The organization diagram 300B is not meant to be exhaustive as many organizations include many different job families. In this example FIG. 3B illustrates an example organization. In the organization diagram 300B, there may be an engineering job family 314, an administrative job family 316, and a managerial job family 318.

The engineering job family 314 may include users who perform engineering job tasks. The computing devices utilized by those in the engineering job family 314 may be unique to the type of work performed by the users within that job family. Likewise, the managerial job family 318 and the administrative job family 316. The new user 320, usually a new employee, or a group transfer may move into one of these job families. The new user 320 may need a selected device 322 that is tailored to the type of work in the job families. Utilizing the knowledge base, information about each of the job families, engineering job family 314, managerial family 318 and administrative job family 316, may be utilized to identify an optimal computing device recommendation and an optimal software application recommendation.

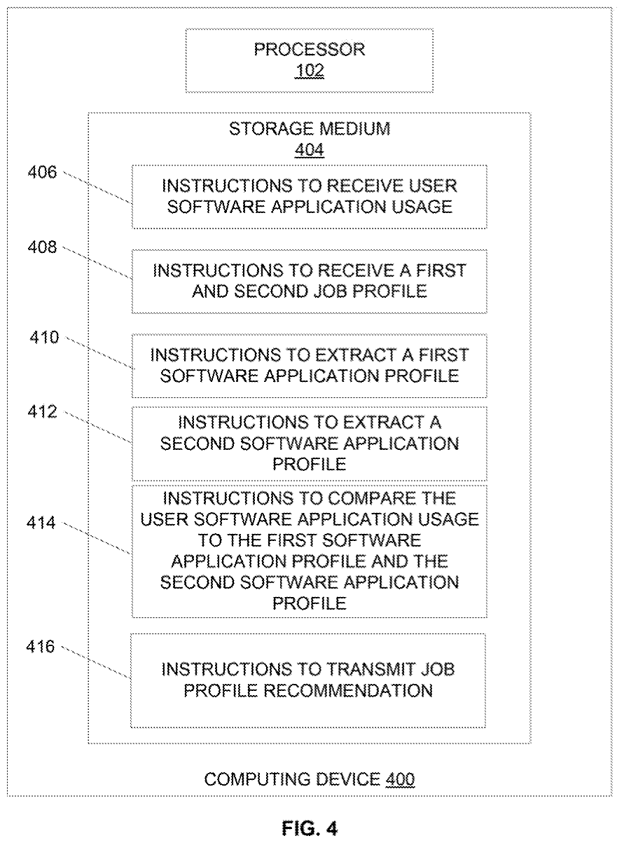

FIG. 4 is a computing device for supporting instructions for creating knowledge base recommendations, according to an example. Utilizing the knowledge base, the computing device 400 may compare the software application usage of a user to that of two different job types within a job family. In doing so, the computing device 400 may make an objective observation that the user may be deserving of a promotion or job title change based on the software usage patterns. The computing device 400 depicts a processor 102 and a storage medium 404 and, as an example of the computing device 400 performing its operations, the storage medium 404 may include instructions 406-416 that are executable by the processor 102. The processor 102 may be synonymous with the processor 102 referenced in FIG. 1. Additionally, the processor 102 may include but is not limited to central processing units (CPUs). The storage medium 404 can be said to store program instructions that, when executed by processor 102, implement the components of the computing device 400.

The executable program instructions stored in the storage medium 404 include, as an example, instructions to receive usage software application usage 406. As described previously in reference to the user usage data, software usage may correspond to what software applications a user is utilizing and a duration of each of the software applications are being used. The storage medium 404 may include instructions to receive a first and second job profile 408. The first and second job profiles may correspond to profiles, as described above, corresponding to the user's current job family or job title and a target job family or job title. For example, the first software application profile comprises a first set of common application utilized in the first job profile and the second software application profile comprises a second set of common applications utilized in the second job profile. The instructions to extract a first software application profile 410 and instructions to extract a second software application profile 412 correspond to identifying a set of software application unique to the each of the two job profiles. The first software application profile and the second software application profile may be extracted from a constructed knowledge base for an organization based on their respective job profiles. The storage medium 404 may include instructions to compare the user software application usage to the first software application profile and the second software application profile 414. By comparing the software usage to the first and second software application profiles, the computing device 400 may determine a likeness of the user software application usage to one of the two software application profiles. The storage medium 404 may include instructions to transmit job profile recommendation 416. Based on the comparison, the instructions the job profile recommendation may include a percentage “likeness” of the user software application usage to one of the two software application profiles to a third-party system. The third-party system may be similar to a human resources system as described previously. The transmitted job profile recommendation may provide an objective input into a job promotion or job transfer process within the third-party human resources process.

Storage medium 404 represents generally any number of memory components capable of storing instructions that can be executed by processor 102. Storage medium 404 is non-transitory in the sense that it does not encompass a transitory signal but instead is made up of at least one memory component configured to store the relevant instructions. As a result, the storage medium 404 may be a non-transitory computer-readable storage medium. Storage medium 404 may be implemented in a single device or distributed across devices. Likewise, processor 102 represents any number of processors capable of executing instructions stored by storage medium 404. Processor 102 may be integrated in a single device or distributed across devices. Further, storage medium 404 may be fully or partially integrated in the same device as processor 102, or it may be separate but accessible to that computing device 400 and the processor 102.

In one example, the program instructions 406-416 may be part of an installation package that, when installed, can be executed by processor 102 to implement the components of the computing device 400. In this case, storage medium 404 may be a portable medium such as a CD, DVD, or flash drive, or a memory maintained by a server from which the installation package can be downloaded and installed. In another example, the program instructions may be part of an application or applications already installed. Here, storage medium 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a non-transitory computer readable storage medium;
a processor to retrieve and execute instructions on the storage medium, the instructions to:
receive user usage data from a telemetry agent;
create a knowledge base based in part of the usage data;
segment the knowledge base based on a profile;
determine an optimal computing device recommendation based on the profile;
determine an optimal software application recommendation based on the profile; and
transmit the optimal computing device recommendation and the optimal software application recommendation to a provisioning system.

2. The system of claim 1 wherein the profile corresponds to a job family.

3. The system of claim 2 wherein the optimal software application recommendation corresponds to a set of software applications commonly used by the job family.

4. The system of claim 2, the instructions to segment comprise instructions to group the job family from the knowledge base exclusive of a user node.

5. The system of claim 1 wherein the usage data corresponds to a software usage pattern of a user.

6. A method comprising:
receiving user usage data from a telemetry agent;
receiving a job family from a third-party system;
creating a knowledge base based in part of the usage data and the job family;
correlating the usage data, the job family, and a user based on the knowledge base;
creating a profile based on the correlation;
determining an optimal computing device recommendation based on the profile;
determining an optimal software application recommendation based on the profile; and
transmitting the optimal computing device recommendation and the optimal software application recommendation to a provisioning system.

7. The method of claim 6 wherein the profile corresponds to a job family.

8. The method of claim 6 wherein the optimal software application recommendation corresponds to a set of software applications commonly used by the job family.

9. The method of claim 6, the creating further comprising grouping the job family from the knowledge base exclusive of a user node.

10. The method of claim 6 wherein the usage data corresponds to a software usage pattern of a user.

11. A non-transitory computer readable medium comprising instructions executable by a processor to:
receive user software application usage data from telemetry agent;
receive a first job profile and a second job profile from a third-party system;
extract a first software application profile from a knowledge base, where the first software application profile corresponds to the first job profile;
extract a second software application profile from the knowledge base, wherein the second application profile corresponds to the second job profile;
compare the user software application usage data to the first software application profile and the second application profile;
transmit a job profile recommendation to the third-party system, based on the comparison.

12. The computer readable medium of claim 11 wherein the job profile recommendation corresponds to a promotion.

13. The computer readable medium of claim 11 wherein the user software application usage data corresponds to a set of software applications utilized by a user and a duration the user executes each of the set of software applications.

14. The computer readable medium of claim 11 wherein the first software application profile comprises a first set of common application utilized in the first job profile.

15. The computer readable medium of claim 14, wherein the second software application profile comprises a second set of common applications utilized in the second job profile.
